(19) United States
(12) Patent Application Publication
(10) Pub. No.: US 2025/0201127 A1
(43) Pub. Date: Jun. 19, 2025

(54) METHOD FOR DRIVING NEGOTIATION AND VEHICLE FOR DRIVING NEGOTIATION

(71) Applicant: HYUNDAI AUTOEVER CORP., Seoul (KR)

(72) Inventors: JaeHyun LIM, Seoul (KR); KyungTaek KIM, Seoul (KR); SungJin CHOI, Seoul (KR)

(21) Appl. No.: 18/978,943

(22) Filed: Dec. 12, 2024

(30) Foreign Application Priority Data
Dec. 15, 2023 (KR) 10-2023-0183378

(51) Int. Cl. G08G 1/00; H04L 5/00; H04W 4/40

(52) U.S. Cl. CPC G08G 1/22; H04L 5/0055; H04W 4/40

(57) ABSTRACT

Apparatus and methods for driving negotiation are disclosed. According to an embodiment, a method of a first vehicle for driving negotiation includes broadcasting a relay node selection message for driving negotiation, receiving a status information message from at least one first surrounding vehicle or at least one road side unit that receives the relay node selection message, selecting a relay node for driving negotiation from the at least one first surrounding vehicle or the at least one road side unit based on the status information message, transmitting a cooperative request message to the relay node, receiving a cooperative response message of at least one second surrounding vehicle from the relay node, and determining whether a cooperative driving is possible based on the cooperative response message.

### CROSS-REFERENCE TO RELATED APPLICATION

This application claims priority from and the benefit of Korean Patent Application No. 10-2023-0183378, filed on Dec. 15, 2023, which is hereby incorporated by reference for all purposes as if set forth herein.

### BACKGROUND

### Field

Exemplary embodiments of the present disclosure relates to a method for driving negotiation and a vehicle for driving negotiation.

### Discussion of the Background

A cooperative intelligent transportation system (C-ITS), which represents the next generation ITS, refers to the next-generation ITS centered on traffic safety that continuously shares data in both directions of vehicle to vehicle and vehicle to infrastructure to enable preemptive response and prevention of unexpected situations, beyond the intelligent transport system (ITS) that is a traffic management-centric structure providing information to vehicles in one direction from the transport infrastructure.

Regarding the next generation ITS, researches are also actively being conducted to introduce connected vehicles. The connected vehicles refer to vehicles that provide connectivity based on vehicle to everything (V2X) communication to the existing vehicles that are driven stand-alone, These connected vehicles aim to identify traffic flow, accident situations, etc., and provide or use various services such as safe driving and traffic congestion prevention through two-way communication between vehicle to infrastructure (V2I), vehicle and network (V2N), vehicle to vehicle (V2V), vehicle to nomadic device (V2ND), vehicle to pedestrian (V2P), or vehicle to everything (V2X).

Vehicle communication for vehicle safety has been studied since the early 2000s when dedicated short range communication (DSRC), so-called wireless access for vehicle environment (WAVE), which is an extension of the IEEE 802 series technology, was standardized as IEEE 802.11p, and since early 2015, the standardization movement for vehicle communication using long term evolution (LTE) technology, which is a mobile communication network, has begun in earnest. The international mobile communications standardization organization 3GPP completed standardization for LTE vehicle communication in March 2017, which shortened delay time and supported direct communication between vehicles using LTE technology, thereby laying the foundation for the spread of the vehicle communication. Thereafter, discussions are underway for performance improvement and convergence with 5G (new radio (NR)) communication technology.

There are limits to the stability and response to blind spots or unexpected situations on a road using only sensors of autonomous vehicles. In particular, when various driving situations occur at non-signalized intersections, roundabouts, joining roads, etc., there are still limits to the rapid judgment and stability of autonomous vehicles.

Accordingly, a device for driving negotiation was installed on a road side unit (RSU), and driving negotiation for lane change requests and merging plan sharing, etc., was performed using the device for driving negotiation. In other words, the driving negotiation was performed based on the communication between the device for driving negotiation on the RSU and the vehicle.

However, in the past, there was a problem that the vehicle driving negotiation was impossible when the device for driving negotiation installed on the RSU was broken or when the device for driving negotiation was not present.

### SUMMARY

Various embodiments are directed to providing a method for driving negotiation and a vehicle for driving negotiation capable of performing driving negotiation even when the device for driving negotiation is not present or is broken.

In an embodiment, a method for driving negotiation includes broadcasting, by a first vehicle, a relay node selection message for driving negotiation, receiving, by the first vehicle, a status information message from at least one first surrounding vehicle or road side unit, respectively, that receives the relay node selection message, and selecting a relay node for driving negotiation from among the first surrounding vehicle and the road side unit based on the status information message, transmitting, by the first vehicle, a cooperative request message to the relay node, receiving by the first vehicle, a cooperative response message of at least one second surrounding vehicle from the relay node, and determining, by the first vehicle, whether cooperative driving is possible based on the cooperative response message.

The status information message may include status information including at least one of signal strength, whether firmware is tempered with, breakdown or not, and communication load.

In the selecting of the relay node, the first vehicle may calculate scores of the first surrounding vehicle and the road side unit based on the status information, respectively, and selects the relay node based on the calculated scores.

In the selecting of the relay node, the first vehicle may assign scores to each of the signal strength, whether firmware is tempered with, breakdown or not, and communication load, calculate scores of the first surrounding vehicle and the road side unit, respectively, by adding up the assigned scores, and select the first surrounding vehicle or the road side unit with a highest calculated score as the relay node.

The method for driving negotiation may further include, prior to receiving the cooperative response message, broadcasting, by the relay node, a cooperative relay message including additional information necessary for negotiation in the cooperative request message, and receiving, by the relay node, the cooperative response message from at least one second surrounding vehicle receiving the cooperative relay message and transmitting the received cooperative response message to the first vehicle, in which the cooperative response message may include at least one of vehicle identification information, a timestamp, negotiation response data, and driving status information.

In the receiving of the cooperative response message and transmitting of the received cooperative response message to the first vehicle, when a plurality of cooperative response messages are received, the relay node may set priorities for the plurality of cooperative response messages based on the driving status information, and transmit a corresponding cooperative response message to the first vehicle according to the set priorities.

The driving status information may include at least one of acceleration, expected turn-over time information, past acceleration statistics history, and vehicle weight, and in the receiving of the cooperative response message and transmitting of the received cooperative response message to the first vehicle, the relay node may assign scores to each of the acceleration, expected turn-over time information, past acceleration statistics history, and vehicle weight, and set priorities for the plurality of cooperative response messages by adding up the assigned scores.

In the receiving of the cooperative response message and transmitting of the received cooperative response message to the first vehicle, when the driving status information includes breakdown information, the relay node may filter the cooperative response message and may not transmit the filtered cooperative response message to the first vehicle.

In the receiving of the cooperative response message and transmitting of the received cooperative response message to the first vehicle, the relay node may transmit a response reception acknowledgement message (ACK) to the second surrounding vehicle transmitting the cooperative response message, and when the second surrounding vehicle fails to receive the response reception acknowledgement message (ACK) within a preset timeout, a corresponding second surrounding vehicle may retransmit a cooperative response message including current driving status information and negotiation response data.

In the determining of whether the cooperative driving is possible, the first vehicle may determine that cooperative driving is possible when there is a second surrounding vehicle whose response value to the negotiation of the cooperative response message is agree.

The method for driving negotiation may further include, after the determining of whether the cooperative driving is possible, determining, by the first vehicle, a corresponding vehicle requesting the cooperative driving when the cooperative driving is possible, and performing cooperative driving with the determined corresponding vehicle.

In an embodiment, a vehicle for driving negotiation includes a communication module supporting vehicle to everything (V2X) communication, and a processor connected to the communication module, in which the processor may broadcast a relay node selection message for driving negotiation, receive a status information message from at least one first surrounding vehicle or road side unit that receives the relay node selection message, and select a relay node for driving negotiation from among the first surrounding vehicle and a base station based on the status information message, transmit a cooperative request message to the relay node, receive at least one cooperative response message from the relay node, and determines whether cooperative driving is possible based on the cooperative response message.

The status information message may include status information including at least one of signal strength, whether firmware is tempered with, breakdown or not, and communication load.

The processor may calculate scores of the first surrounding vehicle and the road side unit based on the status information, respectively, and select the relay node based on the calculated scores.

The processor may determine that the cooperative driving is possible when there is a second surrounding vehicle whose response value to the negotiation of the cooperative response message is agree, and determine a corresponding vehicle requesting the cooperative driving and performs cooperative driving with the determined corresponding vehicle, when the cooperative driving is possible.

When the vehicle is selected as the relay node, the processor may generate a first cooperative relay message including additional information necessary for negotiation in the first cooperative request message received by a first vehicle, broadcast the first cooperative relay message, and receive a first cooperative response message from at least one second surrounding vehicle receiving the first cooperative relay message and transmit the received first cooperative response message to the first vehicle.

When a plurality of first cooperative response messages are received, the processor may set priorities for the plurality of first cooperative response messages based on driving status information included in the first cooperative response messages, and transmit the corresponding first cooperative response message to the first vehicle according to the set priorities.

The driving status information may include at least one of acceleration, expected turn-over time information, past acceleration statistics history, and vehicle weight, and the processor may assign scores to each of acceleration, expected turn-over time information, past acceleration statistics history, and vehicle weight of a plurality of second surrounding vehicles, and set priorities for the plurality of first cooperative response messages based on the assigned scores.

When the driving status information includes breakdown information, the processor may filter the corresponding first cooperative response message and may not transmit the filtered first cooperative response message to the first vehicle.

When the vehicle is a vehicle transmitting a cooperative response message, the processor may transmit the cooperative response message to the relay node when receiving the cooperative relay message, and when a response reception acknowledgement message (ACK) is not received from the relay node within a preset timeout, the processor may retransmit a cooperative response message including current driving status information and negotiation response data.

According to the method for driving negotiation and the vehicle for driving negotiation according to the present disclosure, by selecting the relay node from among the surrounding vehicles/road side units of the vehicle requesting the driving negotiation and performing the driving negotiation through the selected relay node, it is possible to perform the vehicle driving negotiation even when the device for driving negotiation is not present or broken.

In addition, according to the method for driving negotiation and the vehicle for driving negotiation according to the present disclosure, by dynamically setting priorities for the cooperative response message according to the driving status information of the vehicle and transmitting the cooperative response messages according to the priorities, it is possible to first transmit more important cooperative response messages and thus ensure the vehicle safety.

In addition, according to the method for driving negotiation and the vehicle for driving negotiation according to the present disclosure, when the response reception message is not received within a preset timeout, by retransmitting the cooperative response message including driving status information at a current time point in time, the negotiation response data, etc., it is possible to resolve the issue of the message transmission delay due to low priority despite being the important cooperative response message.

### BRIEF DESCRIPTION OF THE DRAWINGS

FIG. 1 is a diagram for describing a method for driving negotiation according to an embodiment of the present disclosure.

FIG. 2 is an exemplary diagram for describing the method for driving negotiation according to an embodiment of the present disclosure.

FIG. 3 is a block diagram schematically illustrating a configuration of a vehicle for driving negotiation according to an embodiment of the present disclosure.

### DETAILED DESCRIPTION OF THE ILLUSTRATED EMBODIMENTS

Hereinafter, embodiments of a method for driving negotiation and a vehicle for driving negotiation according to the present disclosure will be described with reference to the accompanying drawings. In this process, thicknesses of lines, sizes of components, and the like, illustrated in the accompanying drawings may be exaggerated for clearness of explanation and convenience. In addition, terms to be described below are defined in consideration of functions in the present disclosure and may be construed in different ways by the intention of users or practice. Therefore, these terms should be defined on the basis of the contents throughout the present specification.

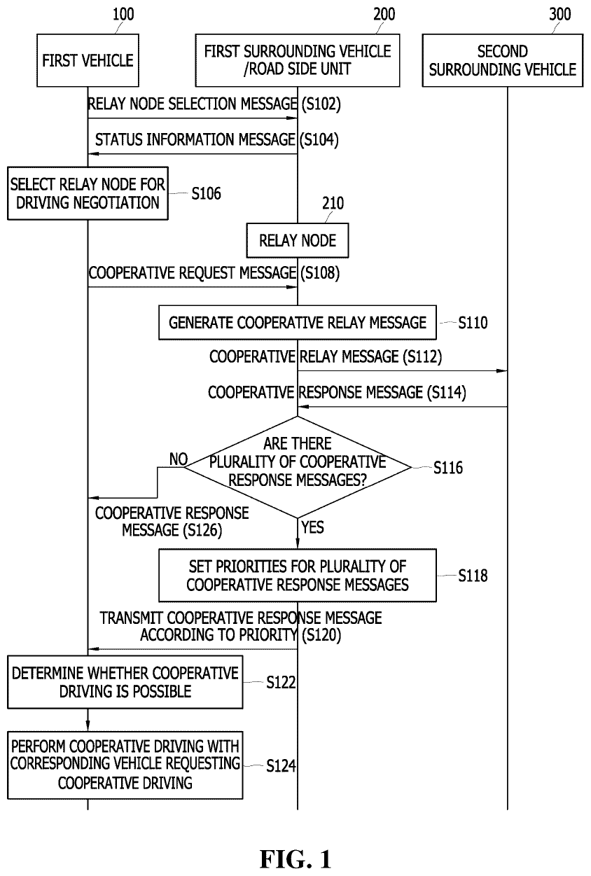

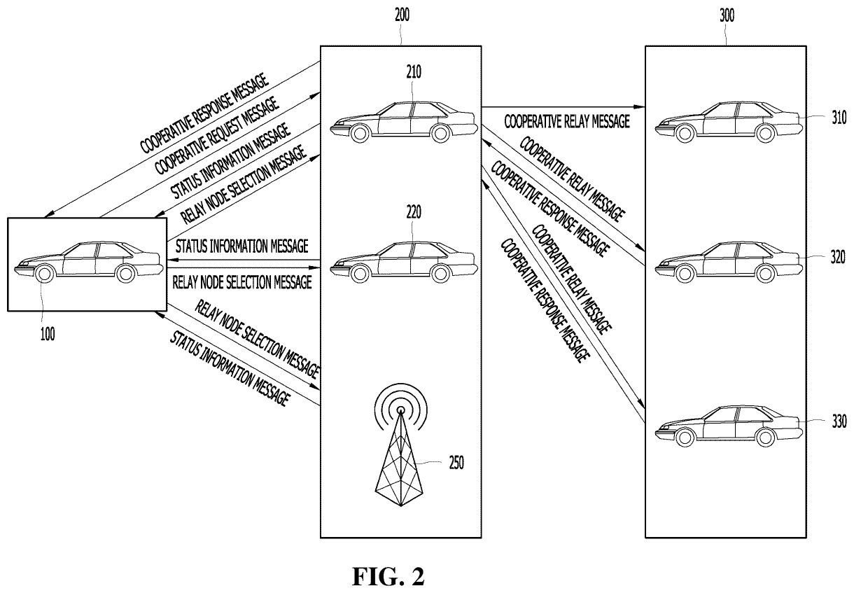

FIG. 1 is a diagram for describing a method for driving negotiation according to an embodiment of the present disclosure, and FIG. 2 is an exemplary diagram for describing the method for driving negotiation according to an embodiment of the present disclosure.

Referring to FIGS. 1 and 2, a first vehicle 100 broadcasts a relay node selection message for driving negotiation (S102). Here, the relay node selection message may include identification information of the first vehicle 100, status information request information, etc.

At least one first surrounding vehicle or base stations 210, 220, and 250 (hereinafter referred to as ‘200’) that receives a relay node selection message by performing step S102 transmits a status information message to the first vehicle 100 (S104). Here, the status information message may include its own identification information, status information, first vehicle identification information, etc. The status information may include signal strength, whether firmware is tempered with, breakdown or not, and communication load, etc. The signal strength may be, for example, RSSI. The firmware tampering status may mean firmware tampering, normal firmware normal, etc., according to the result of the firmware tampering inspection. The communication load may mean a currently used communication load or a spare communication load.

When step S104 is performed, the first vehicle 100 selects the relay node 210 for driving negotiation from among the first surrounding vehicle and the base station 200 based on the status information message (S106).

In this case, the first vehicle 100 may calculate scores of the first surrounding vehicle and the base station 200, respectively, based on the status information included in the status information message, and select the relay node 210 based on the calculated scores. That is, the first vehicle 100 may assign scores to signal strength, whether firmware is tempered with, breakdown or not, and communication load, respectively, and select the relay node 210 from among the first surrounding vehicle and the base station 200 by adding up the assigned scores. In this case, the first vehicle 100 may select the first surrounding vehicle or the base station 200 with the highest score as the relay node 210.

For example, a case where a full score of 10 is assigned to each of the items of signal strength, whether firmware is tempered with, breakdown or not, and communication load will be described. In this case, the first vehicle 100 may assign 0 to 10 points depending on the signal strength, 0 or 10 points depending on the firmware tampering status, 0 or 10 points depending on the malfunction status, and 0 to 10 points depending on the communication load. After that, the first vehicle 100 may calculate the score of the corresponding first surrounding vehicle or base station 200 by calculating the sum of the scores assigned to each item. In this case, the first vehicle 100 may also assign weights according to the importance of each item.

In addition, the first vehicle 100 may exclude vehicles with tampered firmware or broken vehicles, assign scores to each of the signal strength and communication load, and add up the assigned scores to select the first surrounding vehicle or the base station 200 with the highest score as the relay node 210.

Thereafter, the first vehicle 100 may transmit and receive information for driving negotiation through the relay node 210.

When step S106 is performed, the first vehicle 100 transmits a cooperative request message for driving negotiation to the relay node 210 (S108).

Here, the cooperative request message may include vehicle identification information, a timestamp, negotiation request data, etc. The negotiation request data may include request type data such as a speed, a lane change, and a lane join. The data for the vehicle speed may include data elements for overtaking, deceleration, and stop as negotiation message information for a speed adjustment plan. The data for the lane change may include data elements for avoid, accident, cut-in, and pedestrian as the negotiation message information for the lane change plan. The data for the lane join may include data elements for confluence, intersection, and roundabout as negotiation message information for a joining plan.

In addition, the cooperative request message may further include message identification information. The message identification information is a current driving negotiation session identification value, and may be used to define a process from the driving negotiation request to the response as one session.

When step S108 is performed, the relay node 210 generates a cooperative relay message that includes additional information necessary for negotiation in the cooperative request message (S110) and broadcasts the cooperative relay message (S112).

That is, the relay node 210 may generate a cooperative relay message that includes a type code of additional information necessary for negotiation in the cooperative request message, and transmit the cooperative relay message together with the cooperative request message to at least one second surrounding vehicle 310, 320, and 330 (hereinafter referred to as ‘300’) in a broadcast form. Here, the additional information may include information related to a road condition warning for speed change, lane change, lane join, collision warning, collision avoidance, intersection warning, icing, etc., an overpass warning, or toll collection.

In addition, the relay node 210 may generate the cooperative relay message that adds the identification information of the relay node 210 to the cooperative request message, and broadcast the cooperative relay message.

At least one second surrounding vehicle 300 that receives the cooperative relay message by performing step S112 transmits a cooperative response message including driving status information to the relay node 210 (S114).

Here, the cooperative response message may include the vehicle identification information, the timestamp, the negotiation response data, the driving status information, the message identification information, etc. The negotiation response data may include a response value for negotiation of the second vehicle itself and information necessary for the negotiation. The response value for the negotiation may include data elements for agree or reject. The driving status information may include acceleration, expected turn-over time information, past acceleration statistics history, vehicle weight, etc. In addition, the driving status information may include the malfunction status information. The acceleration is information for determining a current urgent vehicle, and may mean the amount of change in the direction and speed of the vehicle. A vehicle with a large acceleration may be determined to be a current urgent vehicle. The expected turn-over time information is information for determining a future urgent vehicle, and may be acquired based on navigation information. The expected turn-over time information may include the remaining time until the turn-over, the expected turn-over time, etc. The past acceleration statistics history means acceleration statistics values for a preset period of time, for example, an average acceleration of the day. The weight of the vehicle may be acquired through a sensor installed in the vehicle.

At least one second surrounding vehicle 300 that has received the cooperative relay message may transmit the cooperative response message, which includes the response value for negotiation and the information necessary for negotiation in the negotiation response data frame, to the relay node 210.

In addition, the second surrounding vehicle 300 may include the message identification information of the vehicle that transmits the negotiation request when transmitting the cooperative response message. In this case, the relay node 210 may confirm to which cooperative request message the currently received cooperative response message is a response. This is useful for efficiently identifying and relaying a specific cooperative response message and a cooperative response message corresponding the specific cooperative response message when processing a plurality of cooperative request messages and a plurality of cooperative response messages in a 1:many (N) or many (M):N environment at the relay node 210.

When step S114 is performed, the relay node 210 determines whether there are the plurality of cooperative response messages (S116). In this case, the relay node 210 may determine whether there are the plurality of cooperative response messages for the corresponding cooperative request message using the message identification information of the cooperative response message.

When there are the plurality of cooperative response messages as a result of the determination in step S116, the relay node 210 sets priorities for the plurality of cooperative response messages (S118). In this case, the relay node 210 may dynamically set priorities for the plurality of cooperative response messages based on the driving status information.

Specifically, the relay node 210 may calculate scores of each cooperative response message based on the driving status information included in the cooperative response message, and set priorities for the cooperative response messages based on the calculated scores. That is, the relay node 210 may assign scores to each of the acceleration, turn-around time information, past acceleration statistics history, and vehicle weight, and set priorities for the plurality of cooperative response messages by adding up the assigned scores. In this case, the relay node 210 may set priorities in order of high scores

For example, a case where 10 points out of 10 points are assigned to each item of the acceleration, expected turn-over time information, past acceleration statistics history, and vehicle weight will be described. In this case, the relay node 210 may be assigned 0 to 10 points according to the acceleration, 0 to 10 points according to the expected turn-over time information, 0 to 10 points according to the past acceleration statistics history, and 0 to 10 points according to the vehicle weight. Thereafter, the relay node 210 may calculate scores of each cooperative response message by calculating the sum of scores assigned to each item. In this case, the relay node 210 may also assign weights according to the importance of each item.

In addition, when the driving status information of the cooperative response message includes breakdown information, the relay node 210 may filter the cooperative response message including the breakdown information so that the cooperative response message is not transmitted to the first vehicle 100.

In addition, when the driving status information of the cooperative response message includes the breakdown information, the relay node 210 may filter the cooperative response message including the breakdown information and dynamically set the priority of the remaining cooperative response messages based on the driving status information included in the remaining cooperative response messages.

In this way, the relay node 210 may analyze the cooperative response message and filter the cooperative response message transmitted to the broken second surrounding vehicle 300, thereby filtering out incorrect information in advance and preventing meaningless control.

In other words, the cooperative response message of the vehicle that is operating normally should be transmitted to the first vehicle 100 so that the first vehicle 100 may make a correct decision when determining a response vehicle for driving negotiation. Therefore, the relay node 210 may filter the cooperative response message transmitted from the broken second surrounding vehicle 300.

In addition, when the cooperative response message of the broken second surrounding vehicle 300 is transmitted to the first vehicle 100, the first vehicle 100 takes a long time to determine on the response vehicle for driving negotiation, and there is a disadvantage that a lot of communication load is consumed. Therefore, the relay node 210 may filter the cooperative response message transmitted from the broken second surrounding vehicle 300.

In addition, by setting the priorities for the plurality of cooperative response messages and transmitting the cooperative response messages to the first vehicle 100 according to the priorities, a more important cooperative response message may be transmitted first, thereby avoiding the worst situation in terms of stability.

Meanwhile, when the cooperative response message is received, the relay node 210 may transmit a response reception confirmation message to the corresponding second surrounding vehicle 300.

The second surrounding vehicle 300 that transmits the cooperative response message to the relay node 210 may receive a response reception acknowledgement message (ack) from the relay node 210 within a preset timeout.

When the second surrounding vehicles 300 transmit many cooperative response messages at the same time, the relay node 210 may not receive the cooperative response message due to problems such as deadlock. In this case, the relay node 210 may not transmit the response reception acknowledgement message to the second surrounding vehicle 300.

Therefore, when the response reception acknowledgement message (ack) is not received within the preset timeout, the second surrounding vehicle 300 may determine that there is a problem and retransmit the cooperative response message including a current time (time stamp), the current driving status information, the negotiation response data, etc., to the relay node 210.

When the response reception message is not received within the preset timeout (timeout), by retransmitting the cooperative response message including the current driving status information, the negotiation response data, etc., the delay in message transmission due to low priority may be resolved despite the cooperative response message being an important message.

When step S118 is performed, the relay node 210 transmits the cooperative response message to the first vehicle 100 according to the priority (S120).

When step S120 is performed, the first vehicle 100 determines whether the cooperative driving is possible based on the cooperative response message (S122), and when the cooperative driving is possible, performs cooperative driving with the corresponding vehicle requesting the cooperative driving (S124).

When there is the second surrounding vehicle 300 whose response value to the negotiation of the cooperative response message is agree, the first vehicle 100 may determine that cooperative driving is possible. When the cooperative driving is possible, the first vehicle 100 may select at least one vehicle, and select the corresponding vehicle requesting the cooperative driving from among the selected vehicles. The first vehicle 100 may determine the corresponding vehicle that is possible for the cooperative driving from among the second surrounding vehicles 300 that transmits the cooperative response message. In this case, the first vehicle 100 may determine the corresponding vehicle by considering the driving information and negotiation request data of the first vehicle 100.

When the corresponding vehicle for driving negotiation is determined, the first vehicle 100 may perform the driving negotiation between the corresponding vehicles that will perform the driving negotiation based on the driving negotiation protocol. In this case, the driving negotiation may be performed based on direct communication between the first vehicle 100 and the corresponding vehicle, or based on the communication between the first vehicle 100 and the corresponding vehicle by the relay node 210. In this case, the driving negotiation protocol may include a process of transmitting and receiving a message for starting cooperative driving between the first vehicle 100 and the corresponding vehicle, a process of notifying the first vehicle 100 and the corresponding vehicle of the start of the cooperative driving, a process of transmitting and receiving a message for ending the cooperative driving between the first vehicle 100 and the corresponding vehicle, and a process of ending the cooperative driving. In this case, when the communication is performed by the relay node 210, the relay node 210 may relay message transmission between the first vehicle 100 and the corresponding vehicle.

In this way, the first vehicle 100 may proceed with the driving negotiation with the corresponding vehicle according to the response value (agree or reject) to the negotiation of the cooperative response message and the message information contents, or transmit another cooperative request message for renegotiation or extension of driving negotiation to the relay node 210 without proceeding with the current driving negotiation session.

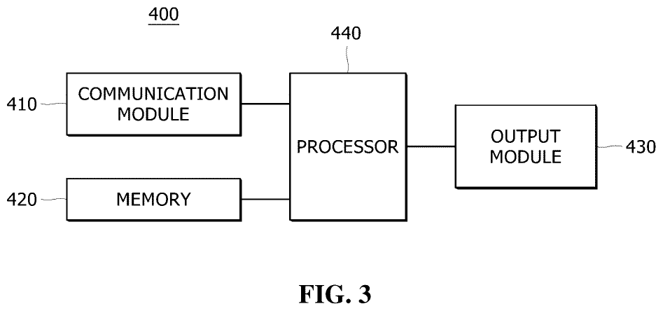

FIG. 3 is a block diagram schematically illustrating a configuration of a vehicle for driving negotiation according to an embodiment of the present disclosure.

Referring to FIG. 3, a vehicle 400 for driving negotiation according to an embodiment of the present disclosure includes a communication module 410, a memory 420, an output module 430, and a processor 440.

The communication module 410 is configured for communication with an RSU or surrounding vehicles through a communication network, and may support vehicle to everything (V2X) communication. In this case, the communication module 410 may be implemented in various forms such as a short-range communication module, a wireless communication module, a mobile communication module, and a wired communication module.

The memory 420 is a configuration that stores data related to an operation of the vehicle 400 for driving negotiation. In particular, the memory 420 may store a relay node selection algorithm for driving negotiation, an operation algorithm for driving negotiation, etc., and the stored information may be selected by the processor 440 if necessary. That is, the memory 420 stores various types of data generated during the execution of an operating system or program (program or applet) for driving the vehicle for driving negotiation. The memory 420 may use the known storage medium, and for example, use one or more of the known storage media such as ROM, PROM, EPROM, EEPROM, RAM, etc.

The output module 430 may output information on a corresponding vehicle, or the like capable of cooperative driving under the control of the processor 440. The output module 430 may include a display module (not illustrated), an audio module (not illustrated), etc. The display module serves to display the information on the corresponding vehicle, or the like capable of the cooperative driving through the processor 440. The display module may be implemented as, for example, a thin film transistor-liquid crystal display (TFT-LCD) panel, a light emitting diode (LED) panel, an organic LED (OLED) panel, an active matrix OLED (AMOLED) panel, a flexible panel, etc. The audio module 430 may output the information on the corresponding vehicle, or the like capable of the cooperative driving under the control of the processor 440. Such an audio module may include, for example, a speaker, etc.

The processor 440 may be operatively connected to the communication module 410, the memory 420, and the output module 430. The processor 440 may be implemented as at least one of a central processing unit (CPU), an application specific integrated circuit (ASIC), a digital signal processor (DSP), a programmable logic device (PLD), a field programmable gate array (FPGA), a micro controller unit (MCU), and a system on chip (SoC), and may be configured to control a plurality of hardware or software components connected to the processor 440 by driving an operating system or an application, perform various data processing and calculations, execute at least one command stored in the memory 420, and store execution result data in the memory 420.

The processor 440 may perform the operation for driving negotiation by selecting the relay node 210 for transmitting and receiving the messages for driving negotiation and transmitting and receiving the cooperative request message and the cooperative response message through the selected relay node 210.

Hereinafter, the operation of the processor 440 will be described in detail.

The operations of the processor 440 may differ depending on the cases where the vehicle is a request vehicle requiring driving negotiation, a vehicle selected as the relay node 210, or a vehicle transmitting the cooperative response message.

First, when the vehicle is the request vehicle requiring the driving negotiation, the operations of the processor 440 will be described.

When the driving negotiation is required, the processor 440 may broadcast a relay node selection message for driving negotiation. Here, the relay node selection message may include the vehicle identification information, the status information request information, etc.

The processor 440 may receive the status information message from at least one first surrounding vehicle or the base station 200 that receives the relay node selection message. Here, the status information message may include its own identification information, the status information, the first vehicle identification information, etc. The status information may include signal strength, whether firmware is tempered with, breakdown or not, and communication load, etc.

The processor 440 may select the relay node 210 for driving negotiation from among the first surrounding vehicle and the base station 200 based on the status information message. In this case, the processor 440 may calculate the scores of the first surrounding vehicle and the base station 200, respectively, based on the status information included in the status information message, and select the relay node 210 based on the calculated scores. That is, the processor 440 may assign scores to signal strength, whether firmware is tempered with, breakdown or not, and communication load, respectively, and select the relay node 210 from among the first surrounding vehicle and the base station 200 by adding up the assigned scores. In this case, the processor 440 may select the first surrounding vehicle or the base station 200 with the highest score as the relay node 210.

When the relay node 210 is selected, the processor 440 may transmit the cooperative request message to the relay node 210 and receive at least one cooperative response message from the relay node 210. Here, the cooperative response message may include the vehicle identification information, the timestamp, the negotiation response data, the driving status information, the message identification information, etc. The negotiation response data may include the response value for negotiation of the second vehicle itself and the information necessary for the negotiation. The response value for the negotiation may include data elements for agree or reject. The driving status information may include the acceleration, the expected turn-over time information, the past acceleration statistics history, the vehicle weight, etc. In addition, the driving status information may include the malfunction status information.

When at least one cooperative response message is received, the processor 440 may determine whether the cooperative driving is possible based on the cooperative response message, and when the cooperative driving is possible, the processor 440 may perform the cooperative driving with the corresponding vehicle requesting the cooperative driving. That is, when there is the second surrounding vehicle 300 whose response value to the negotiation of the cooperative response message is agree, the processor 440 may determine that the cooperative driving is possible. When the cooperative driving is possible, the processor 440 may select at least one vehicle, and select the corresponding vehicle requesting the cooperative driving from among the selected vehicles. When the corresponding vehicle for driving negotiation is determined, the processor 440 may perform the driving negotiation between the corresponding vehicles that will perform the driving negotiation based on the driving negotiation protocol.

Next, the operation of the processor 440 will be described when the vehicle is a vehicle selected as the relay node 210.

In this case, when the cooperative request message is received, the processor 440 may generate a cooperative relay message including additional information necessary for negotiation in the cooperative request message, and broadcast the cooperative relay message. That is, the processor 440 may generate the cooperative relay message that includes a type code of additional information necessary for negotiation in the cooperative request message, and transmit the cooperative relay message together with the cooperative request message to at least one second surrounding vehicle 300 in a broadcast form. Here, the additional information may include information related to a road condition warning for speed change, lane change, lane join, collision warning, collision avoidance, intersection warning, icing, etc., an overpass warning, or toll collection.

In addition, the processor 440 may receive the cooperative response message including the driving status information from at least one second surrounding vehicle 300 that has received the cooperative relay message. Here, the cooperative response message may include the vehicle identification information, the timestamp, the negotiation response data, the driving status information, the message identification information, etc. The negotiation response data may include a response value for negotiation and information necessary for negotiation. The response value for the negotiation may include data elements for agree or reject. The driving status information may include the acceleration, the expected turn-over time information, the past acceleration statistics history, the vehicle weight, etc. In addition, the driving status information may include the malfunction status information.

In addition, when the plurality of cooperative response messages are received, the processor 440 may set priorities for the plurality of cooperative response messages. In this case, the processor 440 may dynamically set priorities for the plurality of cooperative response messages based on the driving status information. Specifically, the processor 440 may calculate scores of each cooperative response message based on the driving status information included in the cooperative response message, and set priorities for the cooperative response messages based on the calculated scores.

Finally, when the vehicle is a vehicle transmitting a cooperative response message, the operation of the processor 440 will be described.

When the cooperative relay message is received, the processor 440 may transmit the cooperative response message including the driving status information, the negotiation response data, etc., to the relay node 210 through the communication module 410.

The processor 440 may receive the number of transmissions of the cooperative response message and the response reception acknowledgement message (ack) from the relay node 210 within a preset timeout (timeout). When the response reception message (ack) is not received within the preset timeout, the processor 440 may retransmit the cooperative response message including the current time (time stamp), the current driving status information, the negotiation response data, etc., to the relay node 210.

When the response reception message is not received within the preset timeout (timeout), by retransmitting the cooperative response message including the current driving status information, the negotiation response data, etc., the delay in message transmission due to low priority may be resolved despite the cooperative response message being an important message.

Meanwhile, although the embodiment of the present disclosure is described as the vehicle for driving negotiation, the vehicle may refer to a vehicle terminal equipped in a vehicle. Such a vehicle terminal may be an on board unit (OBU) equipped in a vehicle and a terminal carried by a user. Here, the terminal carried by the user may be a smartphone, a notebook, a tablet PC, a smart TV, a mobile phone, a personal digital assistant (PDA), a laptop, a media player, a micro server, a global positioning system (GPS) device, an e-book terminal, a digital broadcasting terminal, a navigation, a kiosk, an MP3 player, a digital camera, other mobiles, or a non-mobile computing device, but is not limited thereto. In addition, the user terminal may be a wearable terminal equipped with a communication function and a data processing function, such as a watch, glasses, a hairband, and a ring.

According to the method for driving negotiation and the vehicle for driving negotiation according to the present disclosure, by selecting the relay node from among the surrounding vehicles/road side units of the vehicle requesting the driving negotiation and performing the driving negotiation through the selected relay node, it is possible to perform the vehicle driving negotiation even when the device for driving negotiation is not present or broken.

In addition, according to the method for driving negotiation and the vehicle for driving negotiation according to the present disclosure, by dynamically setting priorities for the cooperative response message according to the driving status information of the vehicle and transmitting the cooperative response messages according to the priorities, it is possible to first transmit more important cooperative response messages and thus ensure the vehicle safety.

In addition, according to the method for driving negotiation and the vehicle for driving negotiation according to the present disclosure, when the response reception message is not received within a preset timeout, by retransmitting the cooperative response message including the current driving status information, the negotiation response data, etc., it is possible to resolve the issue of the message transmission delay due to low priority despite being the important cooperative response message.

Although the present disclosure has been described with reference to embodiments shown in the accompanying drawings, it is only an example. It will be understood by those skilled in the art that various modifications and equivalent other exemplary embodiments are possible from the present disclosure. Accordingly, a true technical scope of the present disclosure is to be determined by the spirit of the appended claims.

What is claimed is:

1. A method of a first vehicle for driving negotiation, comprising:
broadcasting a relay node selection message for driving negotiation;
receiving a status information message from at least one first surrounding vehicle or at least one road side unit that receives the relay node selection message;
selecting a relay node for driving negotiation from the at least one first surrounding vehicle or the at least one road side unit based on the status information message;
transmitting a cooperative request message to the relay node;
receiving a cooperative response message of at least one second surrounding vehicle from the relay node; and
determining whether a cooperative driving is possible based on the cooperative response message.

2. The method of claim 1, wherein the status information message comprises status information of signal strength, whether firmware is tempered with, broken-down or not, or communication load.

3. The method of claim 2, wherein in the selecting of the relay node, the first vehicle calculates scores of the at least one first surrounding vehicle or the at least one road side unit based on the status information, and the first vehicle selects the relay node based on the scores.

4. The method of claim 3, wherein in the selecting of the relay node, the first vehicle assigns individual scores to each of the status information of signal strength, whether firmware is tempered with, broken-down or not, or communication load, calculates the scores of the at least one first surrounding vehicle or the at least one road side unit by adding up the individual scores, and selects from the at least one first surrounding vehicle or the at least one road side unit one with a highest one of the scores as the relay node.

5. The method of claim 1, further comprising:
prior to the receiving of the cooperative response message,
broadcasting, using the relay node, a cooperative relay message including additional information necessary for negotiation in the cooperative request message; and
receiving, using the relay node, the cooperative response message from the at least one second surrounding vehicle receiving the cooperative relay message and transmitting the cooperative response message to the first vehicle,
wherein the cooperative response message includes a vehicle identification information, a timestamp, a negotiation response data, or a driving status information.

6. The method of claim 5, wherein in the receiving of the cooperative response message and the transmitting of the cooperative response message to the first vehicle, when a plurality of cooperative response messages are received, the relay node sets priorities for the plurality of cooperative response messages based on the driving status information, and the relay node transmits a corresponding cooperative response message to the first vehicle according to the priorities.

7. The method of claim 6, wherein the driving status information includes an acceleration, an expected turn-over time information, a past acceleration statistics history, or a vehicle weight, and
in the receiving of the cooperative response message and the transmitting of the cooperative response message to the first vehicle, the relay node assigns respective scores to each of the acceleration, the expected turn-over time information, the past acceleration statistics history, and the vehicle weight, and the relay node sets the priorities for the plurality of cooperative response messages by adding up the respective scores.

8. The method of claim 5, wherein in the receiving of the cooperative response message and the transmitting of the cooperative response message to the first vehicle, when the driving status information includes a breakdown information, the relay node filters the cooperative response message and does not transmit the cooperative response message filtered by the relay node to the first vehicle.

9. The method of claim 5, wherein in the receiving of the cooperative response message and the transmitting of the cooperative response message to the first vehicle, the relay node transmits a response reception acknowledgement message (ACK) to the at least one second surrounding vehicle transmitting the cooperative response message, and
when the at least one second surrounding vehicle fails to receive the response reception acknowledgement message (ACK) within a preset timeout, the at least one second surrounding vehicle retransmits the cooperative response message including the driving status information and the negotiation response data.

10. The method of claim 1, wherein in the determining of whether the cooperative driving is possible, the first vehicle determines that the cooperative driving is possible based on the cooperative response message of the at least one second surrounding vehicle.

11. The method of claim 1, further comprising:
after the determining of whether the cooperative driving is possible, determining, by the first vehicle, a corresponding vehicle requesting the cooperative driving when the cooperative driving is possible, and performing the cooperative driving with the corresponding vehicle.

12. A vehicle for driving negotiation, comprising:
a communication module supporting a vehicle to everything (V2X) communication; and
a processor connected to the communication module,
wherein the processor broadcasts a relay node selection message for driving negotiation,
receives a status information message from at least one first surrounding vehicle or at least one road side unit that receives the relay node selection message,
selects a relay node for driving negotiation from the at least one first surrounding vehicle or at least one base station based on the status information message,
transmits a cooperative request message to the relay node,
receives at least one cooperative response message from the relay node, and
determines whether a cooperative driving is possible based on the cooperative response message.

13. The vehicle for driving negotiation of claim 12, wherein the status information message includes status information of signal strength, whether firmware is tempered with, broken-down or not, or communication load.

14. The vehicle for driving negotiation of claim 13, wherein the processor calculates scores of the at least one first surrounding vehicle or the at least one road side unit based on the status information, and the processor selects the relay node based on the calculated scores.

15. The vehicle for driving negotiation of claim 12, wherein the processor determines that the cooperative driving is possible based on the cooperative response message of the at least one second surrounding vehicle, and
the processor determines a corresponding vehicle requesting the cooperative driving and performs the cooperative driving with the corresponding vehicle when the cooperative driving is possible.

16. The vehicle for driving negotiation of claim 12, wherein when the at least one first surrounding vehicle or the at least one base station is selected as the relay node, the processor generates a first cooperative relay message including additional information necessary for negotiation in the cooperative request message received by the vehicle, broadcasts the first cooperative relay message, and receives a first cooperative response message from the at least one second surrounding vehicle receiving the first cooperative relay message and transmits the first cooperative response message to the vehicle.

17. The vehicle for driving negotiation of claim 16, wherein when a plurality of first cooperative response messages is received, the processor sets priorities for the plurality of first cooperative response messages based on the driving status information included in the first cooperative response messages, and the processor transmits a corresponding first cooperative response message to the vehicle according to the priorities.

18. The vehicle for driving negotiation of claim 17, wherein the driving status information includes an acceleration, an expected turn-over time information, a past acceleration statistics history, or a vehicle weight, and
the processor assigns respective scores to each of the acceleration, the expected turn-over time information, the past acceleration statistics history, or the vehicle weight, and the processor sets the priorities for the plurality of first cooperative response messages based on the respective scores.

19. The vehicle for driving negotiation of claim 17, wherein when the driving status information includes a breakdown information, the processor filters the first cooperative response message and does not transmit the filtered first cooperative response message to the first vehicle.

20. The vehicle for driving negotiation of claim 12, wherein the processor transmits the cooperative response message to the relay node when receiving the cooperative relay message, and
when a response reception acknowledgement message (ACK) is not received from the relay node within a preset timeout, the processor retransmits the cooperative response message including the driving status information and the negotiation response data.
